(19) United States
(12) Patent Application Publication
(10) Pub. No.: US 2012/0072007 A1
(43) Pub. Date: Mar. 22, 2012

(54) FABRIC SELECTION AND PERFORMANCE MATCHING

(75) Inventor: Moshe Rock, Brookline, MA (US)

(73) Assignee: MMI-IPCO, LLC

(21) Appl. No.: 13/250,257

(22) Filed: Sep. 30, 2011

Related U.S. Application Data
(63) Continuation-in-part of application No. 10/824,004, filed on Apr. 14, 2004, now Pat. No. 8,032,247.
(60) Provisional application No. 60/466,360, filed on Apr. 29, 2003.

(51) Int. Cl. G06F 19/00

(52) U.S. Cl. 700/132

(57) ABSTRACT

Methods and apparatus, including computer program products, for fabric selection and performance matching. The method includes selecting a fabric combination from a set of different constructions and materials, the selection being made on a basis of predetermined characteristics of fabric performance and comfort required to meet specified parameters of conditions and manner of use.

### CROSS-REFERENCE TO RELATED APPLICATIONS

This continuation-in-part application claims priority to U.S. patent application Ser. No. 10/824,004, for “Fabric Selection and Performance Matching,” filed Apr. 14, 2004, and to issue as U.S. Pat. No. 8,032,247 on Oct. 4, 2011, which claims priority based on U.S. Provisional Patent Application No. 60/466,360, for “Fabric Selection and Performance Matching,” filed Apr. 29, 2003, the disclosures of which are incorporated here by reference in their entirety.

### BACKGROUND

The present disclosure relates to fabric selection and performance matching.

In the manufacture of clothing, fabric selection for different end uses is often a trade off among competing factors and desires, depending on conditions and manner of final use.

### SUMMARY

The present disclosure provides methods and apparatus, including computer program products, for fabric selection and performance matching.

In general, in one aspect, the disclosure features a method directed to selection of a fabric from a set of fabrics of different constructions and materials, the selection being made on a basis of predetermined characteristics of fabric performance and comfort required to meet specified parameters of conditions and manner of use. The predetermined characteristics of performance and comfort are defined as a proximity range of an energy neutral zone, where a comfort level is in proximity to a desire range. The specified parameters of conditions and use include, for example, comfort, heat, cold, breathability and dryness.

In general, in another aspect, the disclosure features a method including measuring physical data on individual fabric layers and in, combination with other combinations of fabric layers, determining characteristics of fabric performance and manner of use, and storing the measured physical data in conjunction with fabrics.

The method can include displaying the measured physical data in conjunction with fabrics. Storing can include storing technical data sheets with the fabrics and/or retail outlet information with the fabrics.

In one aspect, a computer-implemented method includes determining a quantity representative of heat produced by an individual performing an activity and representative of an environmental condition experienced as the activity is being performed. The method also includes identifying one or more articles of clothing based on properties of the articles of clothing and the quantity to provide a balance between the heat production of the individual and the environmental condition. The method also includes providing information for presenting the one or more identified articles of clothing for selection.

Implementations may include one or more of the following features. The quantity may define a comfort zone that represents the balance between the heat production of the individual and the environmental condition. The environmental condition and the activity of the individual may be provided from a user computing device. Providing information for presenting the one or more identified articles of clothing may include sending the information to a user computing device. Articles of clothing may include one or more fabrics. Identifying the one or more articles of clothing may include identifying a layering of the articles of clothing. The environmental condition may include ambient temperature. The method may further include receiving information representative of a user selection from presented representations of the one or more articles of clothing. The properties of the one or more articles of clothing may be stored remote from a user computing device that provides the information that represents the activity of the individual and the environmental condition experienced by the individual as the activity is being performed. The balance may allow for one or more imbalances.

In another aspect, a system includes a computing device that includes a memory configured to store instructions. The computing device also includes a processor to execute the instructions to perform a method that includes determining a quantity representative of heat produced by an individual performing an activity and representative of an environmental condition experienced as the activity is being performed. The method also includes identifying one or more articles of clothing based on properties of the articles of clothing and the quantity to provide a balance between the heat production of the individual and the environmental condition. The method also includes providing information for presenting the one or more identified articles of clothing for selection.

Implementations may include one or more of the following features. The quantity may define a comfort zone that represents the balance between the heat production of the individual and the environmental condition. The environmental condition and the activity of the individual may be provided from a user computing device. Providing information for presenting the one or more identified articles of clothing may include sending the information to a user computing device. Articles of clothing may include one or more fabrics. Identifying the one or more articles of clothing may include identifying a layering of the articles of clothing. The environmental condition may include ambient temperature. The method may further include receiving information representative of a user selection from presented representations of the one or more articles of clothing. The properties of the one or more articles of clothing may be stored remote from a user computing device that provides the information that represents the activity of the individual and the environmental condition experienced by the individual as the activity is being performed. The balance may allow for one or more imbalances. The computing device may be user computing device, located at a clothing facilitator, etc.

In another aspect, a computer program product tangibly embodied in an information carrier and comprising instructions that when executed by a processor perform a method that includes determining a quantity representative of heat produced by an individual performing an activity and representative of an environmental condition experienced as the activity is being performed. The method also includes identifying one or more articles of clothing based on properties of the articles of clothing and the quantity to provide a balance between the heat production of the individual and the environmental condition. The method also includes providing information for presenting the one or more identified articles of clothing for selection.

Implementations may include one or more of the following features. The quantity may define a comfort zone that represents the balance between the heat production of the individual and the environmental condition. The environmental condition and the activity of the individual may be provided from a user computing device. Providing information for presenting the one or more identified articles of clothing may include sending the information to a user computing device. Articles of clothing may include one or more fabrics. Identifying the one or more articles of clothing may include identifying a layering of the articles of clothing. The environmental condition may include ambient temperature. Further instructions may be included that when executed by a processor perform a method that includes receiving information representative of a user selection from presented representations of the one or more articles of clothing. The properties of the one or more articles of clothing may be stored remote from a user computing device that provides the information that represents the activity of the individual and the environmental condition experienced by the individual as the activity is being performed. The balance may allow for one or more imbalances.

The details of one or more implementations of the disclosure are set forth in the accompanying drawings and the description below. Other features, objects, and advantages of the disclosure will be apparent from the description and drawings, and from the claims.

### DESCRIPTION OF DRAWINGS

FIG. 1 is block diagram.

FIG. 2 is a flow diagram.

FIG. 3 is a block diagram.

FIG. 4 illustrates a network of computing devices and a clothing facilitator.

FIG. 5 illustrates components of a clothing facilitator.

FIG. 6 graphically illustrates operations of a comfort modeler.

FIG. 7 illustrates types of clothing information provided to a user.

FIG. 8 is a flow chart that represents operations of a comfort modeler.

FIG. 9 illustrates components of computing devices.

Like reference symbols in the various drawings indicate like elements.

### DETAILED DESCRIPTION

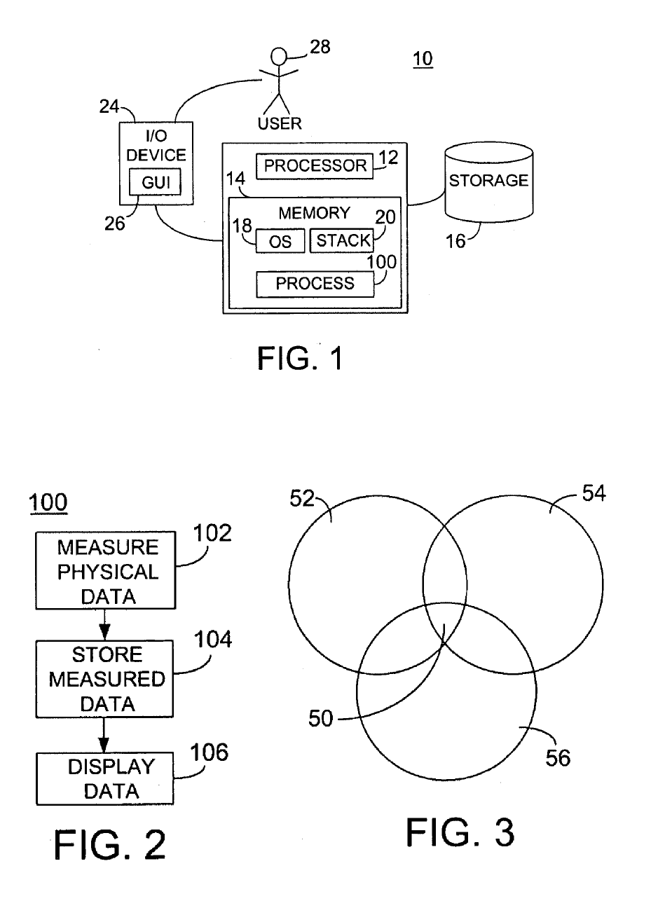

As shown in FIG. 1, a system 10 includes processor 12, memory 14 and storage device 16. Memory 14 includes an operating system (OS) 18, such as Linux, UNIX or Windows® XP, a TCP/IP stack 20 for communicating with a network (not shown), and a process 100 for determining a comfort zone for a garment. System 10 also includes a link to an input/output (I/O) device 24 for display of a graphical user interface (GUI) 26 to a user 28.

As shown in FIG. 2, the process 100 for determining a comfort zone for a garment includes measuring (102) physical data on individual fabric layers and in combination with other fabric layers. Process 100 stores (104) the measured physical data. Process 100 displays (106) the data to an end user (e.g., garment purchaser) who is then able to select an optimal layer in a layering for an intended physical activity in a projected ambient temperature.

In process 100, a physiological evaluation of thermal insulation balance depends on a balance of metabolic energy production (M) and heat loss via convection, conduction, evaporation, and a given ambient environmental condition, such as, for example, temperature, relative humidity and wind speed. The closer to an energy neutral zone, i.e., a minimum heat loss/gain, the greater the comfort level of a human subject. An energy balance is graded as a comfort index compiled to a comfort zone. Physical data is measured or extrapolated and placed into a numerical model, considering garment make up, fitting (e.g., tight fit or loose fit), posture, closures, air gap between layers, and so forth.

The above physical properties are measured, for example, in units of cal/sq. m/hr, on individual fabric layers and in combination with other layers. This data is gathered from laboratory testing in conjunction with a thermal mannequin in a dynamic environment. An end user (e.g., garment purchaser) is then able to select an optimal layer or layers in a layering system for an intended physical activity in a projected ambient temperature. Examples of physical activities include running, walking, hiking, standing and skiing. Example projected ambient conditions include range of temperature, wind speed, altitude, rain, etc.

As shown in FIG. 3, comfort zone 50 includes an intersection of three fabrics (represented as circles) 52, 54, 56. For example, fabric 52 can be a first layer, such as underwear. Fabric 54 can be an insulation layer, and fabric 56 can be a shell layer that gives protection from the environment. A silhouette design (e.g., tight fitting, loose fitting) as well as closure at the neck, calf, and palm, and air gap between layers, can also be taken into consideration. Process 100 enables a consumer to look deeper into characteristics and performance of each fabric 52, 54, 56, and to view specific information on a type of recommended layer, where it can purchased, technical data, etc. Thus, the consumer can select a garment system including individual layers that have technical enhancements when layered together and working in harmony.

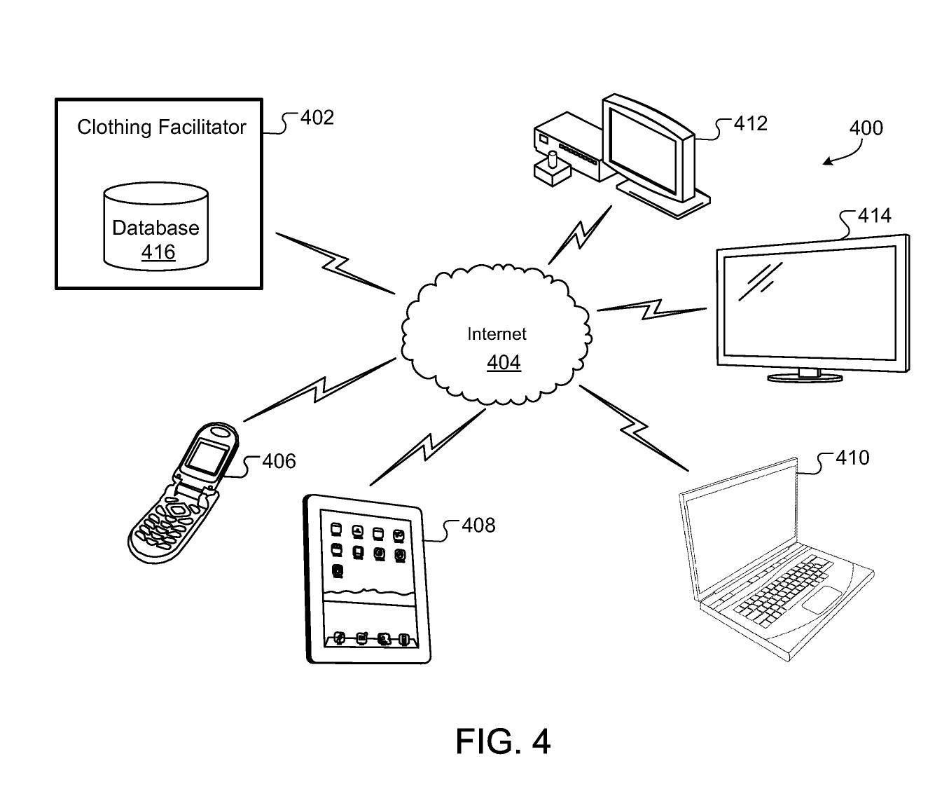

Referring to FIG. 4, a networking environment 400 is presented that provides users (e.g., individuals interested in purchasing one or more garments) access to information collected, produced and stored by a clothing facilitator 402. For example, the clothing facilitator 402 may be an entity (or multiple entities) that employs one or more computing devices (e.g., servers, computer systems, etc.) to process information associated with various articles of clothing (e.g., fabrics, garments, etc.). Along with creating and maintaining libraries of clothing information, the clothing facilitator 402 may also execute operations for managing interactions with users (e.g., providing requested garment information, assisting with fabric or garment selections and purchases, etc.). Through such assistance, particular fabrics, garments and garment sources may be identified and presented to the users based upon user provided information (e.g., intended physical activity, ambient environmental conditions, preferences, etc.) and stored information (e.g., properties of clothing, etc.).

One or more techniques and methodologies may be implemented for exchanging information between the users and the clothing facilitator 402. For example, one or more networks (e.g., the Internet 404) may be employed for interchanging information with user devices. As illustrated in the figure, various types of computing devices and display devices may be employed for information exchange. For example, hand-held computing devices (e.g., a cellular telephone 406, tablet computing device 408, etc.) may exchange information through one or networks (e.g., the Internet 404) with the clothing facilitator 402. Other types of computing devices such as a laptop computer 410 and other computer systems may also be used to exchange information with the clothing facilitator 402. A game console 412 (e.g., connected to a display device such as a television) may also be used for presenting information from the clothing facilitator 402 and receive user input (e.g., indicating an intended activity, clothing selections, etc.). A television 414 or other display device may also present information from the clothing facilitator 402. Televisions and similar display devices may be capable of receiving user input (e.g., from a remote control, linked keyboard, etc.), or, the devices may just present information and a second device (e.g., the cellular telephone 406) may be used for receiving user input and sending the information to the clothing facilitator 402 (e.g., for storage in a database 416, to execute operations, etc.). One or more types of information protocols (e.g., file transfer protocols, etc.) may be implemented exchanging information. The user devices may also present one or more types of interfaces (e.g., graphical user interfaces) to exchange information between the user and the clothing facilitator 402. For example, a network browser may be executed by a user device to establish a connection with a website (or webpage) of the clothing facilitator 402 and provide a vehicle for exchanging information.

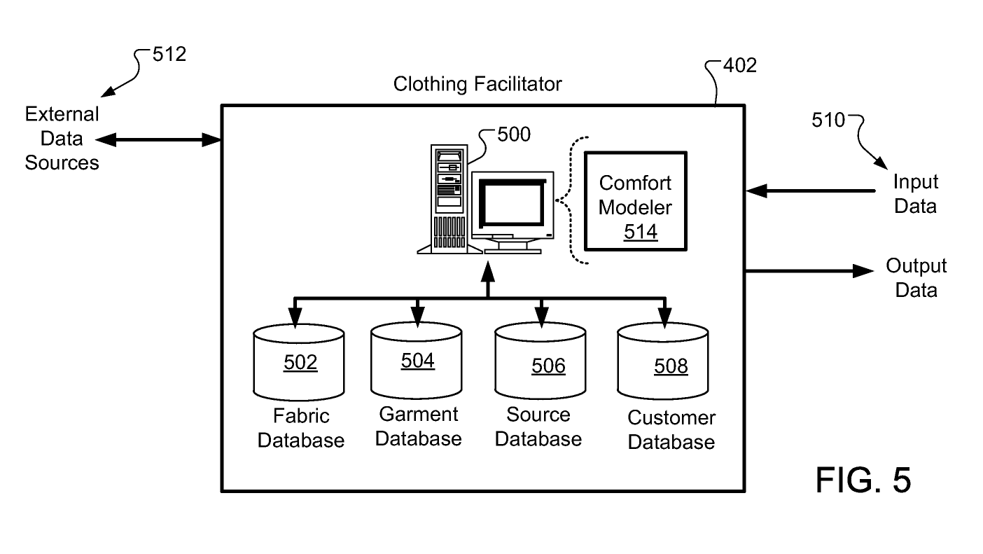

Referring to FIG. 5, various computational techniques and methodologies may be implemented by the clothing facilitator 402 for preparing and providing information. For example, one or more computing devices (represented by a computer system 500) may be used for information processing at the clothing facilitator 402. To exchange information with users, operations may be executed by the computer system 500 and by the user device (e.g., the laptop computer 410 shown in FIG. 4). For example, an application associated with clothing selection may be executed by the user device that exchanges information with one or more applications executed by the computer system 500. Other types of processing architectures may also be implemented by the clothing facilitator 402. For example, applications associated with the clothing facilitator 402 may be delivered as a service (referred to as “cloud computing”) to one or more user devices rather than a product that is executed by a user device (e.g., the cell phone 406 of an end user). As such, computing devices of the clothing facilitator 402 (as represented by the computer system 500), along with computing devices external to the clothing facilitator, may provide the operational functionality to service end users.

To provide such functionality, one or more types of information may be collected and stored, for example, at the clothing facilitator 402. In the illustrated example, four storage devices 502, 504, 506, 508 (e.g., memories, hard drives, CD-ROMs, etc.) represent different types of information associated with identifying clothing (e.g., garments, individual fabrics, fabric layers, etc.). Fabric information, residing in storage device 502, may include characteristics, properties (e.g., performance properties, moisture vapor transmission rate (MVTR), water vapor transmission rate (WVTR), minimum fabric weight, measures of thermal resistance such as clothing insulation (clo unit) or the European units of thermal insulation (Tog), maximum shrinkage measures, air permeability measures, absorbency, wicking measures, measures of inter-fabric moisture transport, stretch, etc.), etc. of various types of individual fabrics (e.g., knits, weaves, etc.) and combinations of fabrics (e.g., fabric laminates, constructs, etc.) and other types of clothing. Various types of data sheets for fabrics, or combination of fabrics (and other types of clothing), which may provide measured data, may also be stored in storage device 502. Garment information, residing the storage device 504, may include characteristics and properties associated with various types of garments (e.g., fitting measures, closures, posture, air gap standoffs between layers, etc.). While the fabric database and the garment database are illustrated in this example as being stored in separate storage devices 502, 504, in some arrangements these databases may be stored on a common device or distributed among more than two storage devices.

Along with storing various properties associated with articles of clothing (e.g., fabrics, garments, etc.) other information may be stored by the clothing facilitator 402. For example, information that identifies clothing sources (e.g., fabric and garment manufacturers, wholesalers, distributors, retail stores, etc.) and various associated information (e.g., brand names, products, serial numbers, etc.). As illustrated, source information is stored in a storage device 506; however, in some implementations the source information may be stored with other types of data on one or more common storage devices. Customer related information may also be stored, for example, in a storage device 508. Along with information associated with individual customers, the storage device 508 may store information associated with physical activities and how these activities relate to the articles of clothing selected by customers. Geographic location, nationality, physical features (e.g., gender, height, weight, etc.) may be recorded in a customer database that resides in storage device 508. Previous purchases and purchasing trends, along with source specific information (e.g., list of previously frequented clothing sources, frequency of purchases, etc.), may be stored for assisting the clothing facilitator 402.

One or more clothing sources may provide the information received by the clothing facilitator 402 and stored (e.g., in storage devices 502-508). For example, input data 510 from users (e.g., customers) may be received from one or more user devices (such as the devices shown in FIG. 4) and processed and stored by the clothing facilitator 402. Email messages and other electronic-based information (e.g., data collected from websites, etc.) may be received as input data 510. Various type of data sources external 512 to the clothing facilitator 402 may also provide information that is stored (and processed) by the clothing facilitator, for example, current stock listings, availability, and other product related information (e.g., data sheets, etc.) may be received from different clothing sources. Provided (and stored), this information can be utilized by the clothing facilitator 402 to assist users (e.g., customers) with identifying one or more articles of clothing (e.g., garments, fabrics, etc.), or combinations of articles for purchase. For example, based upon user-supplied information that indicates a physical activity of interest (e.g., running, hiking, skating, etc.) and environmental conditions for the activity (e.g., excessive heat, extreme cold, foul weather, etc.), the clothing facilitator 402 can assist the customer with identifying appropriate articles of clothing (e.g., fabrics, fabric layers, garments, etc.) for taking part in the activity under the provided conditions. To provide this functionality, the computer system 500 may execute a comfort modeler 514 that uses the provided information (e.g., stored in the storage devices 502-508, user input 510, external data sources 512, etc.) to assist the customer with identifying appropriate articles of clothing. In this implementation, the comfort modeler 514 is executed on a single computing device (e.g., computer system 500) located at the clothing facilitator 402; however, one or more other architectures may be employed. For example, the comfort modeler 514 may be completely or partially executed remote from the clothing facilitator 402 (e.g., portions executed by a user device). A distributed architecture may also be implemented, such that one computer device is not overly taxed to execute the process or processes. One or more techniques may be used for a user device to attain a comfort modeler or a portion of a comfort modeler. For example, an application may be downloaded from a server site (e.g., an application that provides the functionality of a comfort modeler is purchased and downloaded from a server site to a tablet computing device as directed by a user).

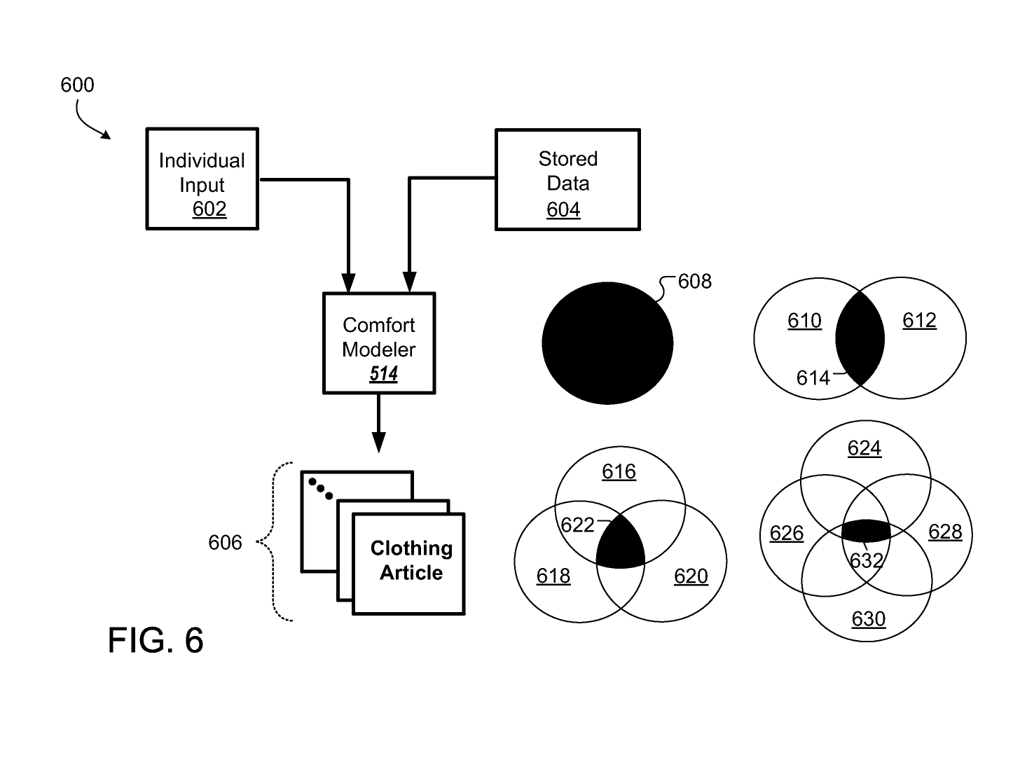

Referring to FIG. 6, a block diagram 600 illustrates an example of the functionality provided by the comfort modeler 514. In general, based upon the information provided, the comfort modeler 514 identifies one or more items of clothing or portions of clothing. In this illustrated example, information 602 is provided from an individual (e.g., a customer interested in purchasing a garment) to the comfort modeler 514 in substantially real-time compared to previously attained information (e.g., stored in the databases of the storage devices 502-508). For example, the information 602 may be provided by an individual using one or more of the devices shown in FIG. 4. Along with identifying the individual (e.g., to assist in the retrieval of previously stored information associated the customer), the information 602 may include information regarding the use of the garment (or garments) of interest. For example, the individual may identify one or more activities (e.g., running, hiking, skating, swimming, etc.) intended to be performed while wearing the garment. Environmental information may also be supplied in the information 602 from the individual. For example, climate conditions (e.g., temperature range, humidity levels, wind speeds, season, etc.) and/or location description (e.g., general description such as “desert”, marine environment, etc., specific locations as defined by latitude and longitude, geographical locations such as “northern Europe”, etc.) may be provided by the individual. Along with being provided by the actual user, the individual input information 602 may be provided by one or more devices, with or without being triggered by the user. For example, the location information (e.g., latitude and longitude, etc.) of the user device may be provided by the device (e.g., a global positioning system included in the device).

In addition to the information 602 provided by the individual, stored information 604 may also be provided to the comfort modeler 514. For example, various amount of data stored at the clothing facilitator 402 (e.g., in storage devices 502-508) may be provided to the comfort modeler 514 for identifying appropriate articles of clothing for the inquiring individual. Based upon the information provided, the comfort modeler 514 can determine and identify the articles and the manner of wearing the articles (e.g., positioning the articles as layers) for the interested individual (e.g., for purchasing).

One or more techniques and methodologies may be utilized by the comfort modeler 514 for identifying clothing articles 606. In general, the comfort modeler 514 seeks to use the information 602 provided by the individual and the stored information 604. For example, the comfort modeler 514 may seek to achieve thermo-physiological comfort for the individual by selecting one or more articles of clothing to maintain thermal equilibrium between the body of the wearer and the environment. To produce a thermal balance among the received information, thermal comfort may considered as being maintained when the heat generated by an individual (e.g., due to their metabolism) is allowed to dissipate (e.g., through one or more layers of clothing) and maintain a thermal equilibrium. For the heat production portion of the thermal balance, one or more quantities may be modeled, for example, heat generated or heat rate (e.g., metabolic rate) based upon physical characteristics (e.g., surface area) of the individual (or of the individual for whom the clothing is being purchased). The planned activity of the individual (while wearing the purchased clothing article(s)) may also be included in the calculation. For example, metabolic rate values or similar quantities (e.g., watts, Btu per hour, etc.), which generally increase with the level of activity, may be determined. Along with quantifying heat production (e.g., heat generated, heat rate, etc.), the comfort modeler 514 may also quantify heat loss through one or more phenomena such as heat conduction, convection, radiation, evaporative loss of heat, etc. by using the received information 602, 604. To determine the thermal balance, the comfort modeler 514 also uses the insulation properties of one or more layers of clothing (e.g., clo units, R-values, etc.) as provided by the stored information 604 (or external information sources). Environmental conditions may also be quantified and used by the comfort modeler 514. Such conditions may be related to environmental heat (e.g., temperature), moisture (e.g., relative humidity), air movement (e.g., air velocity), etc.

Along with thermo-physiological comfort, the comfort modeler 514 may also quantify other comfort categories such as tactile comfort, aesthetic comfort, etc. In general, tactile comfort may be considered as related to mechanical interactions (e.g., friction, etc.) between articles of clothing (e.g., fabrics, etc.) and the wearer's body during an activity of interest. Aesthetic comfort may be considered as being based upon subjective feelings, fashion trends, etc. that may influence purchasing preferences.

Based upon the received information, the comfort modeler 514 can produce one or more comfort indices. For example, by seeking to calculate a thermal balance, and potentially determining that thermal loading may occur due to an imbalance, one or more comfort indices may be quantified. In general, comfort indices may be considered as limits (e.g., thermal limits) that define boundaries (e.g., precautionary limits, thresholds not be exceeded, etc.) for maintaining comfort. Within the limits defined by the comfort indices, a comfort zone may be defined that represents the state in which an individual may be considered comfortable given the received information (e.g., heat production, environmental conditions, etc.) and computations executed by the comfort modeler 514 (e.g., calculating thermal balance to identify thermal loading). In some arrangements, a balance (e.g., thermal balance) may allow from some imbalances to achieve a state considered to be comfortable. As such, imbalance to some degree may be acceptable to define a comfort zone (e.g., some thermal loading deemed acceptable for a thermal balance).

Once calculated, the comfort zone may be used by the comfort modeler 514 to identify one or more garments, fabrics, or other articles of clothing 606 such that a wearer of the article or articles would be placed in a state of comfort as defined by the zone. Along with identifying articles of clothing for the torso and/or legs of an individual, articles maybe identified for other portions of the body such the feet (e.g., footwear, shoes, socks, etc.), the head (e.g., hats, scarfs, headgear, etc.), the hands (e.g., gloves, mittens, etc.), etc. As illustrated in the figure, dependent upon the properties, characteristics, and features of different articles of clothing, one or more articles may be used to achieve the comfort zone. For example, one garment represented by an entirely darkened circle 608 illustrates that the properties of the garment can place the wearer within a comfort zone. Multiple articles of clothing (e.g., layered articles) may also place the wearer in the comfort zone while providing enhanced benefits when compared to a single garment (e.g., ease of movement, lower cost, etc.). For example, the darkened overlap region 614 of two circles 610, 612, which respectively represent two articles of clothing, illustrates the use of two articles to place the wearer in the comfort zone as calculated by the comfort modeler 514. Similarly, darkened region 622 represents the comfort zone that can be achieved from three articles of clothing represented by circles 616, 618 and 620. Though possibly more difficult to achieve, an arrangement of four articles of clothing (represented by circles 624, 626, 628 and 630) may be used to place the wearer in the comfort zone (as indicated by the darkened region 632). As such, along with determining the comfort zone needed for an individual (e.g., to perform an activity within a particular environment), the comfort modeler 514 may be capable of identifying one or more articles of clothing and combinations (layers) of clothing articles to achieve the calculated comfort zone.

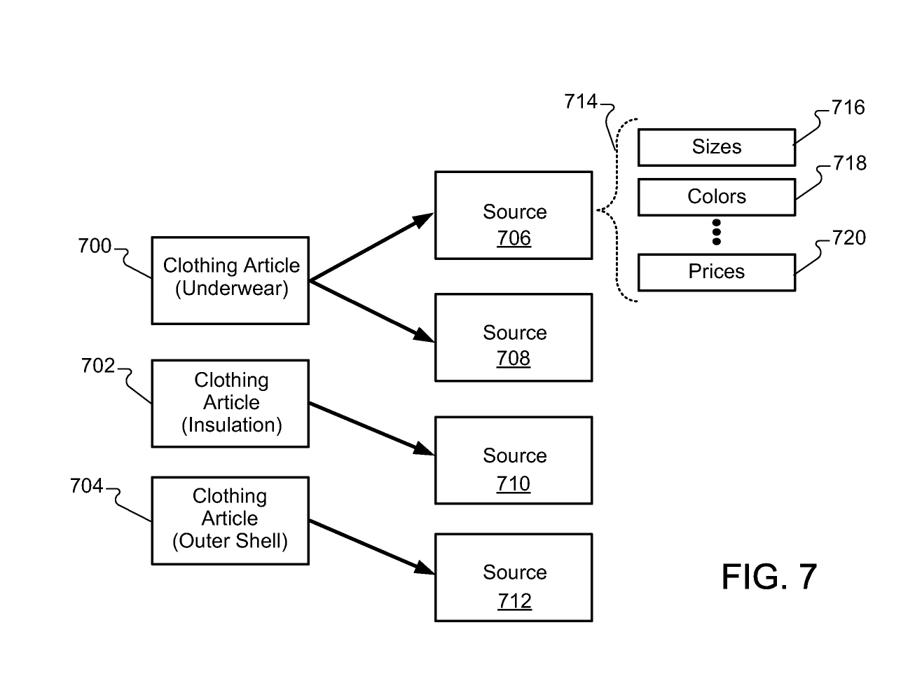

Referring to FIG. 7, the comfort modeler 514 may also provide additional information for an identified article of clothing (or multiple articles) for assisting an individual (e.g., with a potential purchase). For example, information that identifies clothing sources (e.g., manufacturer, wholesaler, retailer, etc.) along with related information (e.g., available sizes, colors, optional features, prices, etc.) may also be provided for the identified articles of clothing. In this illustrated example, the comfort modeler 514 has identified three articles of clothing 700, 702, 704 (e.g., to be worn as three layers) that place the wearer in a comfort zone (as computed by the comfort modeler). In particular, clothing article 700 (e.g., underwear) is worn beneath the other two layers, and clothing article 704 (e.g., an outer shell) is worn over a middle clothing article 702 (e.g., an insulation layer).

For each of the identified articles 700, 702, 704, the comfort modeler 514 (FIG. 5) identifies one or more sources for the respective articles from one or multiple information sources (e.g., the source database residing in the storage device 506, also shown in FIG. 5). In this example, two sources 706, 708 are identified for clothing article 700 while just single sources (e.g., source 710, source 712) are identified for respective clothing articles 702 and 704. Along with sending information e.g. to a user device to identify these sources, other information may be provided, such as a uniform resource locator (URL) for the source or a webpage from the source that presents the associated article of clothing. As illustrated, further information is also provided to the user device, which may be attained from databases (e.g., fabric database from storage device 502, garment database from storage device 504, source database from storage device 506, etc.) of the clothing facilitator 402, or from one or more sources external to the clothing facilitator (e.g., source websites, electronic catalogs, etc.). As illustrated with bracket 714, a collection of information (e.g., available sizes 716, colors 718, prices 720, etc.) are collected and provided to the user device to aid the user (e.g., with selection of a desirable clothing article). Other types of information may also be provided to assist the user. For example, images of the clothing (that may dynamically change to present different colors, textures, etc.), representations of the article as being worn by the user (e.g., determined from physical characteristics retrieved from the customer database residing in storage device 508), and other visual representations may be provided to a user (e.g., on a web browser being executed by the user device). Similarly, imagery of the combined articles (e.g., layered articles as worn by the user) may also be provided to the user device. Customer feedback regarding these or other clothing articles (e.g., previous purchases), the sources (e.g., long-time customers), etc. may also be provided along with other types of information that may assist the user with current and future transactions. Along with being provided feedback, operations may be performed to collect feedback information. For example, feedback may be collected by operations executed by the comfort modeler 514, by other processes executed at the clothing facilitator 402, processes executed by a user device, processes executed at various combinations of the clothing facilitator 402 and one or more user devices, etc. Through such collections, information may be shared among multiple individuals (e.g., previous and potential customers).

Similar to identifying articles of clothing from activity and environmental information (provided by an individual), the comfort modeler 514 may also provide suggestions based on different information (provided by an individual). For example, provided the identity of one or more articles of clothing, the comfort modeler 514 may be capable of determining various uses of the clothing articles (e.g., athletic activities) under different conditions (e.g., environmental conditions such as different temperature ranges, humidity ranges, etc.). In one example, an article of clothing may be identified to the comfort modeler 514 from a user device (e.g., a barcode of the article of clothing is entered into a smart phone by a user and provided to a comfort modeler being executed by the phone, at a clothing facilitator, a combination of both, etc.). Provided this information (and possibly similar information for other articles of clothing), the comfort modeler 514 can determine if one or more comfort zones can be achieved from the clothing articles for various activities under different conditions. Along with the information associated with the clothing articles (e.g., as provided from the barcodes), other information may be used by the comfort modeler 514 for determining comfort zones (e.g., for identifying the use of the clothing articles individually or in combination). Once the comfort zone(s) are determined and the use(s) for the article of clothing identified (e.g., different activities for different conditions), the information may be provided to the user device for inspection. As such, an individual may be able to determine uses for a particular article of clothing (or multiple articles) prior to completing a transaction (e.g., purchase). Further, from information associated with individual (e.g., currently owned articles of clothing identified from information stored in the customer database 508), the comfort modeler 514 may be able to identify activities and conditions for use of the clothing article with the individual's current (or future) wardrobe.

Information exchanging between the clothing facilitator 402 and an individual may be expanded to include one or more additional individuals. For example, one or more social networking techniques and architectures may be employed in concert with the functionality of the comfort modeler 514. In one arrangement, the external data sources 512 (shown in FIG. 5), which can communicate with the clothing facilitator 402, may include one or more social networks. As such, along with information provided from an individual (e.g., using a user device) to the comfort modeler 514, information may also be exchanged with other individuals (e.g., members of a “circle of friends”), groups (e.g., members of a group that includes the individual such as alumni of a particular school), institutions (e.g., members of a professional association), etc. As such, information (e.g., feedback, input information such as activities and environmental conditions, etc.) may be provided, reviewed, edited, etc. by multiple individuals.

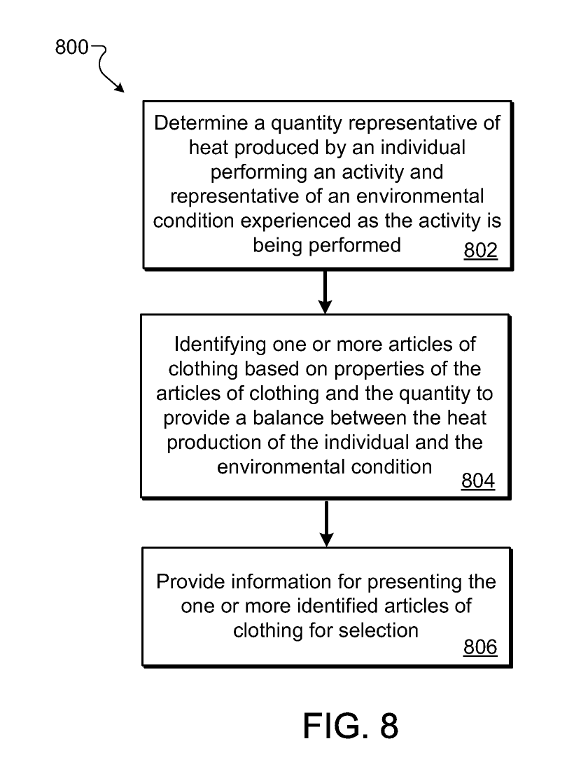

Referring to FIG. 8, a flowchart 800 graphically illustrates operations of the comfort modeler 514 as being executed by a computing device such as the computer system 500 (shown in FIG. 5). Such operations are typically executed by components (e.g., one or more processors) included in a single computing device; however, operations may be executed by multiple devices. Along with being executed at a single site (e.g., clothing fabricator 402, a user device, etc.), operations may be executed in a distributed manner at two or more locations.

Operations of the clothing modeler may include determining 802 a quantity representative of heat produced by an individual performing an activity and/or representative of an environmental condition experienced as the activity is being performed. For example, it may calculate quantities (e.g., comfort indices, a comfort zone, etc.) to seek to balance metabolic production of an individual and the heat loss through convection, conduction and evaporation based on provided information (e.g., user activity, ambient temperature, relative humidity, wind speed, etc.). Operations may also include identifying 804 one or more articles of clothing based on properties of the articles of clothing, and their quantity to provide a balance between the heat production of the individual and the environmental condition. For example, to substantially maintain the temperature of the individual while performing an activity identified by the individual (e.g., running) for a particular climate (e.g., high heat and temperature), appropriate fabrics and garments are identified (e.g., a single-fabric garment capable of billowing during movement to create air currents that increase evaporation and cooling). For user-identified activities in colder climates, the comfort modeler may identify other articles of clothing (e.g., a multi-layer garment with properties to evacuate skin humidity while also seeking to match the heat production of the individual to heat losses due to wind, heat radiation, etc.). Operations of the comfort modeler may also include providing 806 information for presenting the one or more identified articles of clothing for selection. For example, information that identifies the articles of clothing may be sent from the clothing facilitator 402 to one or more user devices (shown in FIG. 4) for presentation to an end user, and for possible selection (e.g., for a purchase transaction).

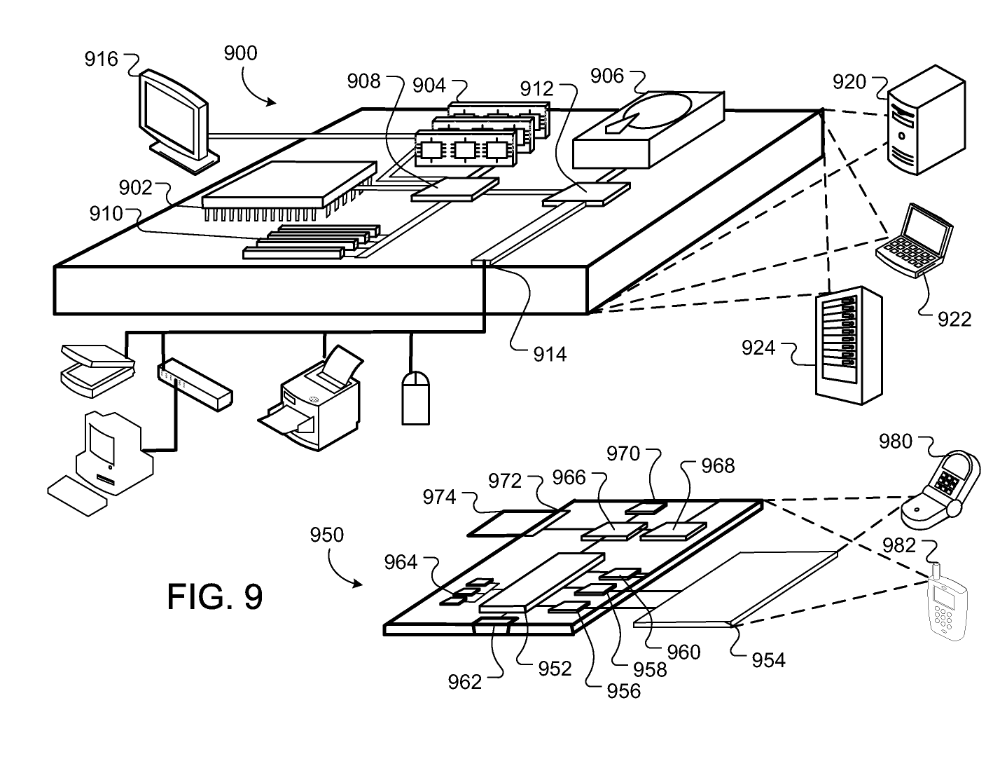

FIG. 9 shows an example of example computer device 900 and example mobile computer device 950 that can be used to implement the techniques described herein. For example, a portion or all of the operations of the comfort modeler 514 may be executed by the computer device 900 (located at the clothing facilitator 402) and/or by the mobile computer device 950 (operated by an end user). Computing device 900 is intended to represent various forms of digital computers, including, e.g., laptops, desktops, workstations, personal digital assistants, servers, blade servers, mainframes, and other appropriate computers. Computing device 950 is intended to represent various forms of mobile devices, including, e.g., personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 900 includes processor 902, memory 904, storage device 906, high-speed interface 908 connecting to memory 904 and high-speed expansion ports 910, and low speed interface 912 connecting to low speed bus 914 and storage device 906. Each of components 902, 904, 906, 908, 910, and 912, are interconnected using various busses, and can be mounted on a common motherboard or in other manners as appropriate. Processor 902 can process instructions for execution within computing device 900, including instructions stored in memory 904 or on storage device 906 to display graphical data for a GUI on an external input/output device, including, e.g., display 916 coupled to high speed interface 908. In other implementations, multiple processors and/or multiple buses can be used, as appropriate, along with multiple memories and types of memory. Also, multiple computing devices 900 can be connected, with each device providing portions of the necessary operations (e.g., as a server bank, a group of blade servers, or a multi-processor system).

Memory 904 stores data within computing device 900. In one implementation, memory 904 is a volatile memory unit or units. In another implementation, memory 904 is a non-volatile memory unit or units. Memory 904 also can be another form of computer-readable medium, including, e.g., a magnetic or optical disk.

Storage device 906 is capable of providing mass storage for computing device 900. In one implementation, storage device 906 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 904, storage device 906, memory on processor 902, and the like.

High-speed controller 908 manages bandwidth-intensive operations for computing device 900, while low speed controller 912 manages lower bandwidth-intensive operations. Such allocation of functions is an example only. In one implementation, high-speed controller 908 is coupled to memory 904, display 916 (e.g., through a graphics processor or accelerator), and to high-speed expansion ports 910, which can accept various expansion cards (not shown). In the implementation, low-speed controller 912 is coupled to storage device 906 and low-speed expansion port 914. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 900 can be implemented in a number of different forms, as shown in the figure. For example, it can be implemented as standard server 920, or multiple times in a group of such servers. It also can be implemented as part of rack server system 924. In addition or as an alternative, it can be implemented in a personal computer including, e.g., laptop computer 922. In some examples, components from computing device 900 can be combined with other components in a mobile device (not shown), including, e.g., device 950. Each of such devices can contain one or more of computing device 900, 950, and an entire system can be made up of multiple computing devices 900, 950 communicating with each other.

Computing device 950 includes processor 952, memory 964, an input/output device including, e.g., display 954, communication interface 966, and transceiver 968, among other components. Device 950 also can be provided with a storage device, including, e.g., a microdrive or other device, to provide additional storage. Each of components 950, 952, 964, 954, 966, and 968, are interconnected using various buses, and several of the components can be mounted on a common motherboard or in other manners as appropriate.

Processor 952 can execute instructions within computing device 950, including instructions stored in memory 964. The processor can be implemented as a chipset of chips that include separate and multiple analog and digital processors. The processor can provide, for example, for coordination of the other components of device 950, including, e.g., control of user interfaces, applications run by device 950, and wireless communication by device 950.

Processor 952 can communicate with a user through control interface 958 and display interface 956 coupled to display 954. Display 954 can be, for example, a TFT LCD (Thin-Film-Transistor Liquid Crystal Display) or an OLED (Organic Light Emitting Diode) display, or other appropriate display technology. Display interface 956 can comprise appropriate circuitry for driving display 954 to present graphical and other data to a user. Control interface 958 can receive commands from a user and convert them for submission to processor 952. In addition, external interface 962 can communicate with processor 942, so as to enable near area communication of device 950 with other devices. External interface 962 can provide, for example, for wired communication in some implementations, or for wireless communication in other implementations, and multiple interfaces also can be used.

Memory 964 stores data within computing device 950. Memory 964 can be implemented as one or more of a computer-readable medium or media, a volatile memory unit or units, or a non-volatile memory unit or units. Expansion memory 974 also can be provided and connected to device 950 through expansion interface 972, which can include, for example, a SIMM (Single In Line Memory Module) card interface. Such expansion memory 974 can provide extra storage space for device 950, or also can store applications or other data for device 950. Specifically, expansion memory 974 can include instructions to carry out or supplement the processes described above, and can also include secure data. Thus, for example, expansion memory 974 can be provided as a security module for device 950, and can be programmed with instructions that permit secure use of device 950. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 964, expansion memory 974, and/or memory on processor 952 that can be received, for example, over transceiver 968 or external interface 962.

Device 950 can communicate wirelessly through the communication interface 966, which can include digital signal processing circuitry where necessary, or where desired. Communication interface 966 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 968. In addition, short-range communication can occur, including, e.g., using a Bluetooth®, WiFi, or other such transceiver (not shown). In addition, GPS (Global Positioning System) receiver module 970 can provide additional navigation- and location-related wireless data to device 950, which can be used as appropriate by applications running on device 950.

Device 950 also can communicate audibly using audio codec 960, which can receive spoken data from a user and convert it to usable digital data. Audio codec 960 can likewise generate audible sound for a user, including, e.g., through a speaker, e.g., in a handset of device 950. Such sound can include sound from voice telephone calls, can include recorded sound (e.g., voice messages, music files, and the like) and also can include sound generated by applications operating on device 950.

Computing device 950 can be implemented in a number of different forms, as shown in the figure. For example, it can be implemented as cellular telephone 980. It also can be implemented as part of smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include: a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

In some implementations, the engines described herein can be separated, combined or incorporated into a single or combined engine. The engines depicted in the figures are not intended to limit the systems described here to the software architectures shown in the figures.

Processes described herein and variations thereof (referred to as “the processes”) include functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of implementations have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

What is claimed is:

1. A computer-implemented method, comprising:
determining a quantity representative of heat produced by an individual performing an activity and representative of an environmental condition experienced as the activity is being performed;
identifying one or more articles of clothing based on properties of the articles of clothing and the quantity to provide a balance between the heat production of the individual and the environmental condition; and
providing information for presenting the one or more identified articles of clothing for selection.

2. The computer-implemented method of claim 1, wherein the quantity defines a comfort zone that represents the balance between the heat production of the individual and the environmental condition.

3. The computer-implemented method of claim 1, wherein the environmental condition and the activity of the individual is provided from a user computing device.

4. The computer-implemented method of claim 1, wherein providing information for presenting the one or more identified articles of clothing includes sending the information to a user computing device.

5. The computer-implemented method of claim 1, wherein articles of clothing include one or more fabrics.

6. The computer-implemented method of claim 1, wherein identifying the one or more articles of clothing includes identifying a layering of the articles of clothing.

7. The computer-implemented method of claim 1, wherein the environmental condition includes ambient temperature.

8. The computer-implemented method of claim 1, further comprising:
receiving information representative of a user selection from presented representations of the one or more articles of clothing.

9. The computer-implemented method of claim 1, wherein the properties of the one or more articles of clothing are stored remote from a user computing device that provides the information that represents the activity of the individual and the environmental condition experienced by the individual as the activity is being performed.

10. The computer-implemented method of claim 1, wherein the balance allows for one or more imbalances.

11. A system comprising:
a computing device comprising:
a memory configured to store instructions; and
a processor to execute the instructions to perform a method comprising:
determining a quantity representative of heat produced by an individual performing an activity and representative of an environmental condition experienced as the activity is being performed;
identifying one or more articles of clothing based on properties of the articles of clothing and the quantity to provide a balance between the heat production of the individual and the environmental condition; and
providing information for presenting the one or more identified articles of clothing for selection.

12. The system of claim 11, wherein the quantity defines a comfort zone that represents the balance between the heat production of the individual and the environmental condition.

13. The system of claim 11, wherein the environmental condition and the activity of the individual is provided from a user computing device.

14. The system of claim 11, wherein providing information for presenting the one or more identified articles of clothing includes sending the information to a user computing device.

15. The system of claim 11, wherein articles of clothing include one or more fabrics.

16. The system of claim 11, wherein identifying the one or more articles of clothing includes identifying a layering of the articles of clothing.

17. The system of claim 11, wherein the environmental condition includes ambient temperature.

18. The system of claim 11, wherein the method further comprising:
receiving information representative of a user selection from presented representations of the one or more articles of clothing.

19. The system of claim 11, wherein the properties of the one or more articles of clothing are stored remote from a user computing device that provides the information that represents the activity of the individual and the environmental condition experienced by the individual as the activity is being performed.

20. The system of claim 11, wherein the balance allows for one or more imbalances.

21. The system of claim 11, wherein the computing device is user computing device.

22. The system of claim 11, wherein the computing device is located at a clothing facilitator.

23. A computer program product tangibly embodied in an information carrier and comprising instructions that when executed by a processor perform a method comprising:
determining a quantity representative of heat produced by an individual performing an activity and representative of an environmental condition experienced as the activity is being performed;
identifying one or more articles of clothing based on properties of the articles of clothing and the quantity to provide a balance between the heat production of the individual and the environmental condition; and
providing information for presenting the one or more identified articles of clothing for selection.

24. The computer program product of claim 23, wherein the quantity defines a comfort zone that represents the balance between the heat production of the individual and the environmental condition.

25. The computer program product of claim 23, wherein the environmental condition and the activity of the individual is provided from a user computing device.

26. The computer program product of claim 23, wherein providing information for presenting the one or more identified articles of clothing includes sending the information to a user computing device.

27. The computer program product of claim 23, wherein articles of clothing include one or more fabrics.

28. The computer program product of claim 23, wherein identifying the one or more articles of clothing includes identifying a layering of the articles of clothing.

29. The computer program product of claim 23, wherein the environmental condition includes ambient temperature.

30. The computer program product of claim 23, further comprising instructions that when executed by a processor perform a method comprising:
receiving information representative of a user selection from presented representations of the one or more articles of clothing.

31. The computer program product of claim 23, wherein the properties of the one or more articles of clothing are stored remote from a user computing device that provides the information that represents the activity of the individual and the environmental condition experienced by the individual as the activity is being performed.

32. The computer program product of claim 23, wherein the balance allows for one or more imbalances.
